(19) United States
(12) Patent Application Publication
(10) Pub. No.: US 2004/0120097 A1
(43) Pub. Date: Jun. 24, 2004

(54) Methods of forming metal-insulator-metal capacitors

(76) Inventors: Stephen T. Chambers, Portland, OR (US); John Barnak, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/329,214

(22) Filed: Dec. 23, 2002

(51) Int. Cl. H01G 4/00

(52) U.S. Cl. 361/301.2

(57) ABSTRACT

Methods for fabricating a capacitor in a microelectronic device utilizing a sputter deposition technique for forming a capacitor dielectric material on a copper-containing plate of the capacitor. Such a sputter deposition technique can be achieved at about room temperature, which should not induce stresses on the copper-containing plate, and, thus, should not generate hillocks.

### BACKGROUND OF THE INVENTION

1. Field of the Invention

The present invention relates generally to the manufacture of microelectronic devices. In particular, the present invention relates to the formation of metal-insulator-metal capacitors in a microelectronic device.

2. State of the Art

Decoupling capacitors are generally used in microelectronic devices to reduce noise due to inductive and capacitive parasitics by providing a stable supply of power to circuitry within the microelectronic devices. A capacitor is a passive electronic component that stores energy in the form of an electrostatic field. In its simplest form, as shown in FIG. 10, a capacitor 200 consists of a first conductive plate 202, connected to a first electrical terminal 204, and a second conductive plate 206, connected to a second electrical terminal 208, separated by an insulating material, called the capacitor dielectric 212. The capacitance of the capacitor 200 is directly proportional to the surface area of the first conductive plate 202 and the second conductive plate 206, and is inversely proportional to the separation between the plates. Capacitance also depends on the dielectric constant of the capacitor dielectric 212 separating the first conductive plate 202 and the second conductive plate 206.

Capacitors 200 are generally formed by patterning a trench in an interlayer dielectric material 214 depositing a first metal layer, such as copper or aluminum, in the trench to form the first conductive plate 202. The capacitor dielectric 212, such as silicon nitride, is deposited over the interlayer dielectric 214 and the first conductive plate 202 by a technique called plasma enhanced chemical vapor deposition (hereinafter “PECVD”). PECVD involves performing a chemical reaction within a plasma field. For example, in the deposition of silicon nitride dielectric layer, silane gas and ammonia gas (or nitrogen gas) are reacted in a plasma at between about 200 and 400 degrees Celsius, as follows:

SiH₄(gas)+NH₃(or N₂)(gas)→SiₓN_{y}H_{z}(solid)+H₂(gas)

A second metal layer, such as copper, tantalum, and the like, is deposited over the capacitor dielectric 212. The second conductive plate 206 is formed by patterning a resist material on the second metal layer proximate the first conductive plate 202 and etching the second metal layer. This forms the capacitor 200, as shown in FIG. 11.

In order to increase the speed and reliability of integrated circuitry, the electronics industry has moved away from using aluminum to using copper or copper alloys as a preferred material for such integrated circuitry. Copper has a lower resistivity (resulting in lower resistance-capacitance interconnect delay) and better electromigration characteristics than aluminum. One problem that can occur in the use of copper as conductive material is the formation of hillocks due to stresses built up in the copper structures as a result of various processing steps in forming integrated circuits. Hillocks are spike-like projections that erupt and protrude from the conductive copper structures in response to compressive stresses which buildup in the copper conductive structures. As shown in FIG. 12, hillocks 216 erupting from the first conductive plate 202 can extend through the capacitor dielectric 212 to contact the second conductive plate 206. This can create a short circuit between the first conductive plate 202 and the second conductive plate 206, which renders the capacitor 200 inoperative.

Therefore, it would be advantageous to develop a method to form capacitors in a manner that reduces or substantially eliminates stress build-up in the first conductive plate, such that the possibility of hillock formation is reduced.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1-9 are side cross-sectional views of a method of forming a capacitor, according to the present invention;

FIG. 10 is a schematic of capacitor, as known in the art;

FIG. 11 is a side cross-sectional view of a capacitor, as known in the art; and

FIG. 12 is a side cross-sectional view of a capacitor illustrating hillocks erupting from the first conductive plate, as known in the art.

### DETAILED DESCRIPTION OF THE ILLUSTRATED EMBODIMENT

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention relates to a process in the fabrication of a capacitor including using a sputter deposition technique for the formation of a capacitor dielectric material layer.

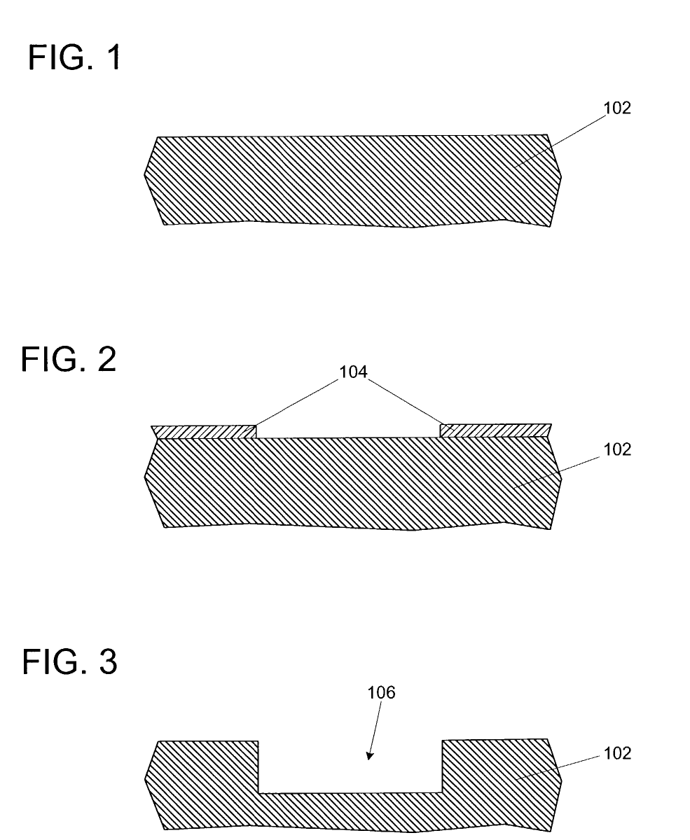

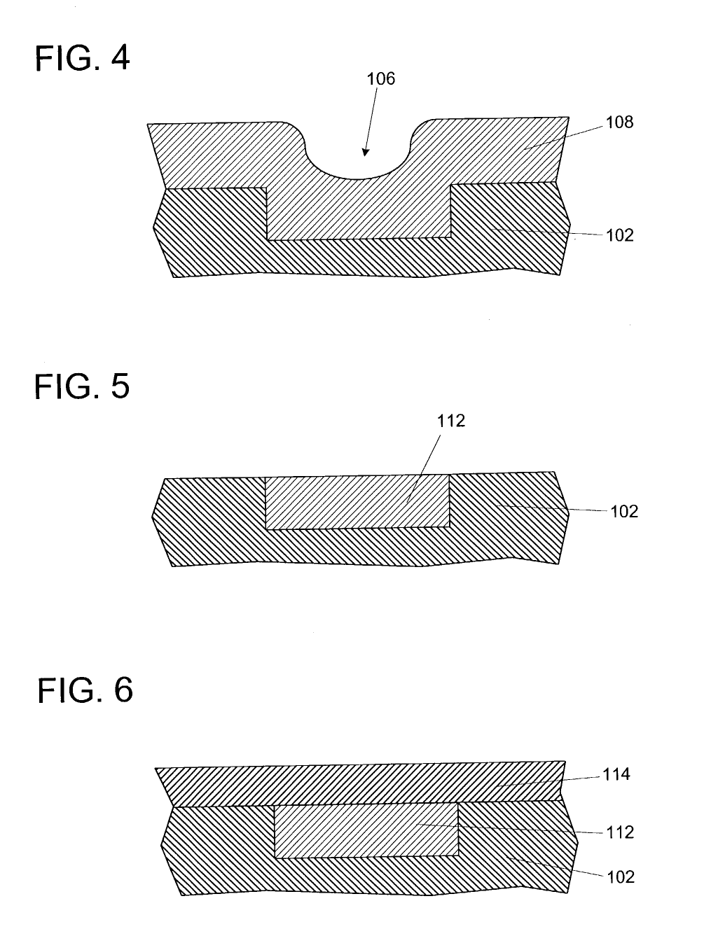

FIGS. 1-9 illustrate a method of fabricating a metal-insulator-metal (hereinafter “MIM”) capacitor. FIG. 1 illustrates an interlayer dielectric material 102, including but not limited to silicon dioxide, silicon nitride, and the like, such as would be found in a build-up layer of a microelectronic device, as will be understood by those skilled in the art. A resist material 104 is patterned on the interlayer dielectric material 102, as shown in FIG. 2. The interlayer dielectric material 102 is then etched, as known in the art, and the resist material 104 (see FIG. 2) is removed forming a trench 106 in the interlayer dielectric material 102, as shown in FIG. 3. A copper-containing material layer 108 is then deposited on the interlayer dielectric material 102 to substantially fill the trench 106, as shown in FIG. 4. The copper-containing material layer 108 may be pure copper or any alloy thereof. It is, of course, understood that if the interlayer dielectric material 102 is a material, which will not prevent copper from diffusing therein, a diffusion barrier layer (not shown) may be necessary prior to depositing the copper-containing material layer 108, as will be understood to those skilled in the art. Furthermore, it is understood that a seed layer (not shown) may be used to provide nucleation sites for the subsequent deposition of the copper-containing material layer 108.

The portion of the copper-containing metal layer 108 that does not extend into the trench 106 (see FIG. 3) is removed by any known method in the art, including but not limited to, chemical mechanical polishing (preferred), dry etching, wet etching, and the like, to form a first conductive plate 112, as shown in FIG. 5. A capacitor dielectric material 114 is then deposited by a sputter deposition technique over the interlayer dielectric material 102 and the first conductive plate 112, as shown in FIG. 6.

Sputter deposition, alternatively called physical vapor deposition (PVD), is the most prevalent method of depositing layers of metals. A conventional sputter deposition process is performed using a plasma formed in a sputtering chamber of a sputtering system. The plasma is generated by applying electric power to a low-pressure gas in the vacuum chamber. Ions originating within the plasma bombard a target that is formed of a material that is to be deposited on the surface of interest. The bombarding ions eject material from the target. The ejected material deposits in a layer on the surface of interest.

Sputter deposition is generally used for the deposition of metals, not capacitor dielectric materials. However, the PECVD technique (previously discussed), which is used to deposit such capacitor material, requires relatively high temperatures (i.e., between about 200 and 400 degrees Celsius for the deposition of silicon nitride). It has been found that these high temperatures can create stresses within the first conductive plate 112, which can result in hillock formation thereon during and/or after the deposition of the capacitor dielectric material 114. It has been further found that sputter deposition of capacitor dielectric materials 114, such as silicon nitride, can be achieved at about room temperature (i.e., between about 10 and 30 degrees Celsius). Such a room temperature deposition should not induce stresses on the first conductive plate 112, and, thus, should not generate hillocks. Furthermore, it has been found that the capacitor dielectric material can be sputter deposited to form very thin films providing increased capacitance.

In one embodiment of the present invention, the reactive sputtering is accomplished in a reaction chamber wherein a silicon target is sputtered in a glow discharge (plasma) in the presence of a reactive gas (generally in an inert carrier gas, such as argon (preferred), helium, xenon, neon, and krypton). For example, to form a silicon nitride layer, the reactive gas is nitrogen (N₂). To form a silicon dioxide layer, the reactive gas is oxygen (02). To form a silicon oxynitride layer, the reactive gas is a combination of nitrogen and oxygen. It is, of course, understood that the carrier gas is optional, as even a pure nitrogen gas can be used to from a silicon nitride film. However, in a preferred embodiment between about 30 and 80% nitrogen is the reactive gas with the remaining carrier gas being argon. The silicon target can be single crystal, poly crystalline, or amorphous, and may be intrinsic or doped with N-type or P-type dopants.

In one embodiment of the present invention, a Pulsed DC unit in conjunction with Magnetron sputtering of silicon nitride is preferred. The Pulsed DC unit momentarily reverses the polarity (from negative to positive) of the silicon target during the deposition to eliminate localized charge to build up on the silicon target surface. This Pulsed DC unit also minimizes arcing during processing, as will be understood by those skilled in the art. A typical pulse frequency range is between about 1 to 500 KHz with a preferred range of between about 1 to 100 KHz. The pulse width can be from 1 to 1000 microseconds with a preferred pulse width of about 2 microseconds. The bias is preferably between about 2W and 1000W.

Although Pulsed DC is preferred, a non-pulsed DC deposition of silicon nitride can be preformed so long a the reactive gas is limited to less than about 65% of the total gas flow, as high concentrations may make the plasma unstable and may not even ignite. Furthermore, RF, AC, and Magnetron DC deposition biases may also be used. Moreover, any combination of RF, AC, DC, Pulsed DC, and Magnetron DC may be used in combination to produced the capacitor dielectric materials 114 of the present invention. There are no distinctions that have been found between reactive and non-reactive sputtering. Also, it has been found that a Pulsed DC in conjunction with Magnetron sputtering may result in low defects, minimizes arcing, and permits sputtering of a dielectric surface on a conductive or semi-conductive sputter target.

The following sputter deposition process parameters are for sputtering a silicon nitride film onto a 300 mm wafer. However, the parameters are not limited to a 300 mm sputter deposition tool set, as the process can be used on a 200 mm sputter deposition tool set. The primary difference in the processes is that the DC Power used in the 300 mm process is cut in about half for the 200 mm process. It is, of course, understood that the DC power is matched by matching the deposition rate, but it can range from about 10W to 10000W. The pressure range used in the deposition chamber can be between about 0.1 mTorr and 300 mTorr. The wafer temperature can be controlled from below about 0° C. and 500° C. Sputter deposition of the silicon nitride film is not effected by the wafer temperature, which allows the deposition of the capacitor dielectric materials 114 below 100° C., i.e., independent of the wafer temperature. Wafer temperature can be controlled in the deposition chamber or in a pre-heat chamber. There is no distinction between passive or active heat/cooling of the wafer to control the wafer temperature or a combination of both. Wafer to sputter target spacing is used to control film properties, and is typically in a range from about 30 mm and 450 mm.

The thickness of the capacitor dielectric material 114 is preferably less than about 500 angstroms. However, when the capacitor dielectric material 114 thickness is reduced below about 300 angstroms using a PECVD technique, hillock defects increase dramatically. Thus, the sputter deposition approach of the present invention becomes more attractive, as it allows the thickness less low as about 30 angstroms, so long a pinhole defects do not occur.

Of course, it is understood that although silicon nitride is described, any dielectric material which can be sputter deposited and which is appropriate for use in a capacitor, including but not limited to silicon dioxide and high K dielectric materials, such as barium strontium titanate, strontium titanate, barium titanate, lead zirconium titanate, strontium bismuth tantalate, titanium oxide, tantalum oxide, aluminum oxide, silicate oxide (for example HfSiₓO_{y}), zirconium oxide, lithium oxide, chromium oxide, cesium oxide, rare earth oxides, and lanthanide series oxides, may be used.

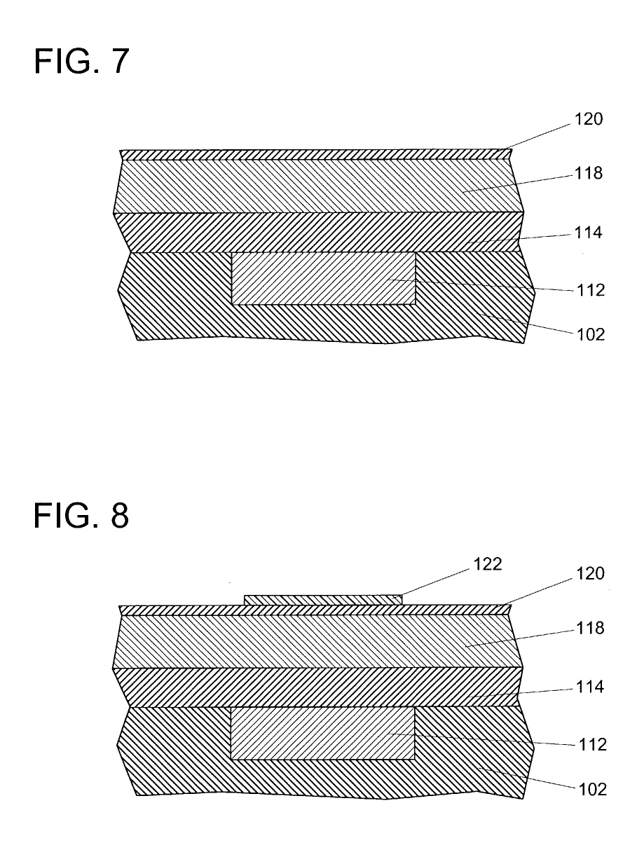

As shown in FIG. 7, a second metal layer 118, such as copper, tantalum (preferred), and the like, is deposited over the capacitor dielectric material 114. The sputter deposition technique can also be used in forming the second metal layer 118, so both the capacitor dielectric material 114 and the second metal layer 118 can be deposited sequentially in the same tool, which saves time and money. Optionally, a barrier layer 120, such as silicon nitride, may be disposed on the second metal layer 118, as also shown.

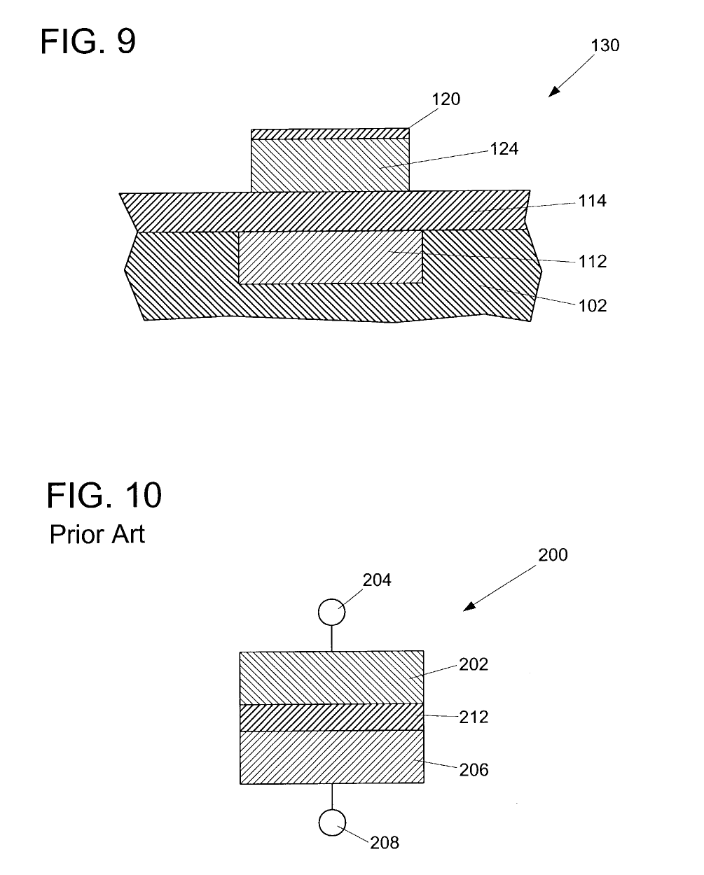

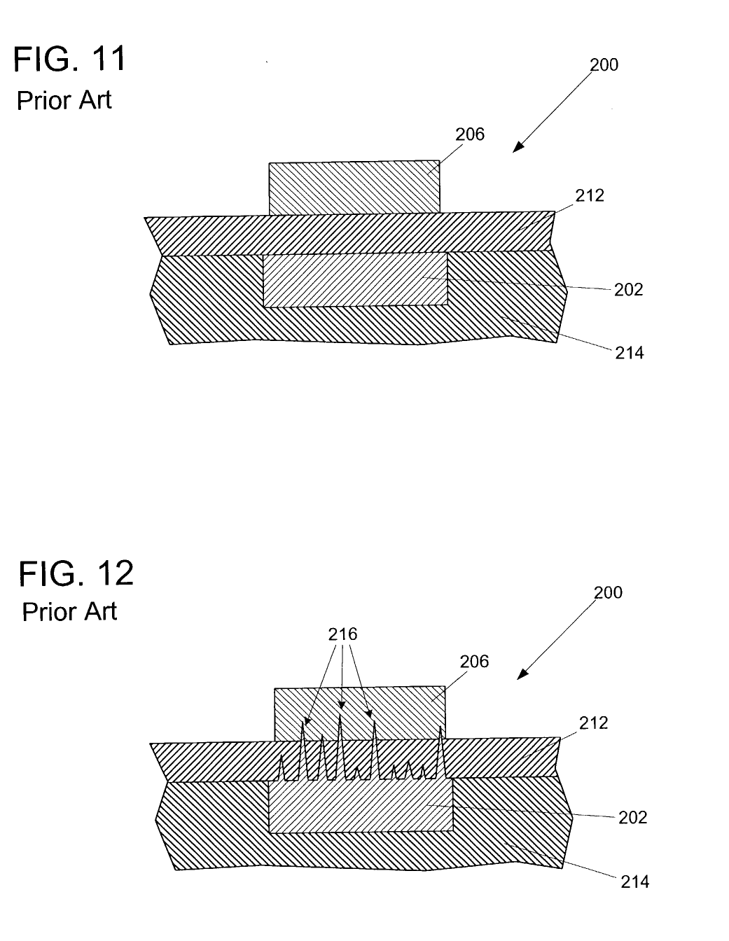

A resist material 122 is then patterned on the second metal layer 118 or on the barrier layer 120 (as shown), if used, proximate the first conductive plate 112, as shown in FIG. 8. The second metal layer 118 is etched to form a second conductive plate 124, thus forming the basic structure of a capacitor 130, as shown in FIG. 9. It is, of course, understood by those skilled in the art that the first conductive plate 112 and the second conductive plate 124 are in electrical contact with their respective electrical terminals (not shown).

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. A method of fabricating a microelectronic capacitor, comprising:
forming a copper-containing conductive plate; and
sputter depositing a dielectric material layer on said copper conductive plate.

2. The method of claim 1, wherein sputter depositing said dielectric material layer comprises sputter depositing said dielectric material on said copper conductive plate at a temperature between about 10 and 30 degrees Celsius.

3. The method of claim 1, wherein sputter depositing said dielectric material layer comprises sputter depositing silicon nitride on said copper-containing conductive plate.

4. The method of claim 3, wherein sputter depositing said silicon nitride comprises sputter depositing said silicon nitride on said copper-containing conductive plate at a temperature between about 10 and 30 degrees Celsius.

5. The method of claim 1, further comprising forming a second conductive plate on said dielectric material layer.

6. The method of claim 5, wherein forming said second conductive plate comprises forming said second conductive plate by sputter deposition.

7. The method of claim 5, wherein forming said second conductive plate comprises forming a tantalum conductive plate.

8. The method of claim 1, wherein forming said copper-containing conductive plate comprises:
forming a trench in an interlayer dielectric material;
depositing a layer of copper-containing material over said interlayer dielectric material to substantially fill said trench; and
removing a portion of said layer of copper-containing material outside of said trench.

9. The method of claim 8, whether removing said portion of said layer of copper-containing material comprises removing said portion of said layer of copper-containing material by chemical mechanical polishing.

10. A method of fabricating a microelectronic capacitor, comprising:
forming a copper-containing conductive plate;
sputter depositing a dielectric material layer on said copper conductive plate; and
forming a second conductive plate on said dielectric material layer.

11. The method of claim 10, wherein sputter depositing said dielectric material layer comprises sputter depositing said dielectric material on said copper conductive plate at a temperature between about 10 and 30 degrees Celsius.

12. The method of claim 10, wherein sputter depositing said dielectric material layer comprises sputter depositing silicon nitride on said copper-containing conductive plate.

13. The method of claim 12, wherein sputter depositing said silicon nitride comprises sputter depositing said silicon nitride on said copper-containing conductive plate at a temperature between about 10 and 30 degrees Celsius.

14. The method of claim 5, wherein forming said second conductive plate comprises forming said second conductive plate by sputter deposition.

15. The method of claim 5, wherein forming said second conductive plate comprises forming a tantalum conductive plate.

16. A microelectronic capacitor, formed by the method comprising:
forming a copper-containing conductive plate; and
sputter depositing a dielectric material layer on said copper conductive plate.

17. The microelectronic capacitor of claim 16, wherein sputter depositing said dielectric material layer comprises sputter depositing said dielectric material on said copper conductive plate at a temperature between about 10 and 30 degrees Celsius.

18. The microelectronic capacitor of claim 16, wherein sputter depositing said dielectric material layer comprises sputter depositing silicon nitride on said copper-containing conductive plate.

19. The microelectronic capacitor of claim 18, wherein sputter depositing said silicon nitride comprises sputter depositing said silicon nitride on said copper-containing conductive plate at a temperature between about 10 and 30 degrees Celsius.

20. The microelectronic capacitor of claim 16, further comprising forming a second conductive plate on said dielectric material layer.

21. The microelectronic capacitor of claim 20, wherein forming said second conductive plate comprises forming said second conductive plate by sputter deposition.

22. The microelectronic capacitor of claim 20, wherein forming said second conductive plate comprises forming a tantalum conductive plate.

23. The microelectronic capacitor of claim 16, wherein forming said copper-containing conductive plate comprises:
forming a trench in an interlayer dielectric material;
depositing a layer of copper-containing material over said interlayer dielectric material to substantially fill said trench; and
removing a portion of said layer of copper-containing material outside of said trench.

24. The microelectronic capacitor of claim 23, whether removing said portion of said layer of copper-containing material comprises removing said portion of said layer of copper-containing material by chemical mechanical polishing.
